(19) United States
(12) Patent Application Publication
(10) Pub. No.: US 2010/0237119 A1
(43) Pub. Date: Sep. 23, 2010

(54) Bicycle Child Seat Mounting Assembly

(75) Inventor: Franciscus Arnoldus Knaven, Doesburg (NL)

Correspondence Address: HOFFMANN & BARON, LLP, 6900 JERICHO TURNPIKE, SYOSSET, NY, 11791, US

(73) Assignee: DREMEFA B.V., Doesburg (NL)

(21) Appl. No.: 12/294,632

(22) PCT Filed: Mar. 29, 2006
(86) PCT No.: PCT/NL2006/000161

§ 371 Date: Sep. 26, 2008

(51) Int. Cl. B62J 1/28; B62J 11/00

(52) U.S. Cl. 224/415; 224/448

(57) ABSTRACT

The invention relates to a mounting assembly for mounting a child seat on a bicycle. The mounting assembly comprises a support member and clamping means for attaching the support member to a head portion of a bicycle frame. The support member is provided with one or more assembly means, which is adapted to cooperate with assembly means provided on the child seat. The support member has a bearing portion for engaging an upper side of a substantially horizontal cross bar of the bicycle frame. The clamping means comprise a first clamping member for engaging a head post of the frame and a second clamping member for engaging a diagonal bracing bar of the frame.

### CROSS-REFERENCE TO RELATED APPLICATIONS

This application is the National Stage of International Application No. PCT/NL2006/000161, filed Mar. 29, 2006, the contents of which is incorporated by reference herein.

### FIELD OF THE INVENTION

The present invention relates to a mounting assembly for mounting a child seat on a bicycle. The mounting assembly comprises a support member and clamping means for attaching the support member to a head portion of a bicycle frame. The support member is provided with one or more receiving sockets each for receiving an assembly member fixedly attached to the child seat and protruding therefrom. The sockets in a mounted state substantially extend parallel with the steering axis.

### BACKGROUND OF THE INVENTION

Child seats which have to be mounted on a front portion of a bicycle are known in the art.

In FIG. 1 is shown a child seat 101 manufactured by the applicant. The seat 101 has as assembly members two assembly pins 102 on the front extending from the seat 101 downwardly. In FIG. 2 is shown a known mounting assembly to attach the seat 101 to the bicycle. A mounting clamp 103 is attached to the steering stem 104 of the bicycle. The mounting clamp 103 has two cylindrical sockets 105 in which the pins 102 of the seat 101 can be inserted. With this known mounting assembly the child seat 101 is turning with the steering stem 104 and thus with the steering handlebar.

In U.S. Pat. No. 3,902,737 is disclosed a child seat with a seat member which is mounted on the bicycle frame. The .child seat has as assembly members downwardly extending tubular leg portions. A clamp comprising a pair of cooperating members is in a mounted state attached to the headpost of the bicycle frame between two frame bars. One of the members has a pair of cylindrical sockets formed on the sides for receiving the leg portions of the seat. The child seat may be removably attached to the clamp by inserting the leg portions in the cylindrical sockets of the clamp. The seat can be simply removed from the bicycle by withdrawing the leg portions from the respective sockets leaving the clamp attached to the bicycle. With this known mounting assembly the child seat does not turn with the steering handlebar.

In recent years all kinds of leisure bicycles have gained more and more popularity. Therefore a whole range of frame shapes and frame structures is found on the bicycle market. A problem that occurs with dedicated mounting assemblies for child seats is that they cannot be fit to a wide range of frames. For example the mounting assembly of U.S. Pat. No. 3,902,737 is suitable to be fit to a bicycle frame wherein the joints between the bars, e.g. a cross bar and a diagonal bracing bar and the head post of the frame leave enough inbetween space such that the clamp may be mounted on the head post. However, leisure bikes like e.g. All Terrain Bikes (ATB) often do not have this space available and a mounting assembly for a child seat cannot be used. Also, often leisure bicycles like ATB's have a relatively short distance between the steering bar and the steering head such that a mounting clamp, which is illustrated in FIG. 2, cannot be used.

### SUMMARY OF THE INVENTION

The invention has for an object to provide an improved mounting assembly for mounting a child seat on a bicycle.

This object is achieved by a mounting assembly for mounting a child seat on a bicycle. The mounting assembly comprises a support member and clamping means for attaching the support member to a head portion of a bicycle frame. The support member is provided with one or more receiving sockets each for receiving an assembly member fixedly attached to the child seat and protruding therefrom. The sockets in a mounted state substantially extend parallel with the steering axis. The support member has a bearing portion for engaging an upper side of a substantially horizontal cross bar of the bicycle frame. The clamping means comprise a first clamping member for engaging a head post of the frame and a second clamping member for engaging a diagonal bracing bar of the frame.

The mounting assembly according to the invention thus has a main body—that is fitted at the upper side of cross bar and has clamping members for fixating the main body with respect to the frame head post and the diagonal bracing bar. This mounting assembly can advantageously be fitted to most bicycle frames with a cross bar and is therefore widely usable.

The clamping means may comprise first tensioning means, in particular screws or bolts, which in a mounted state interconnect the first clamping member and the support member, for bringing the first clamping member and the support member in a clamping engagement with the head post of the bicycle frame.

Advantageously the clamping means comprise second tensioning means, in particular screws or bolts, which in a mounted state interconnect the second clamping member and the support member, for bringing the second clamping member in a clamping engagement with the diagonal bracing bar of the bicycle frame and the support member in a clamping engagement with the cross bar of the bicycle frame.

For most bikes one shaft length of the bolts or screws will be sufficient. However for greater or smaller frame dimensions other lengths can be used. Preferably widely available standard bolts or screws are used as first and/or second tensioning means such that several lengths suitable for the specific bicycle frame dimensions can be easily provided for.

In a preferred embodiment the main body of the support member has an upper plate and two side plates extending from the upper plate, such that the main body has a substantially U-shaped cross section in which the upper plate forms the base of the U and the side plates form the legs of the U, the upper plate in the mounted state being positioned on the upper side of the cross bar of the bicycle frame and the side plates passing along the cross bar. This embodiment provides a receiving space in the main body for the cross bar of the bicycle frame. When the support member is clamped on the frame the receiving space will assure that the support member, but also the child seat attached to it, will be securely fixed with respect to the frame.

In another preferred embodiment the second clamping member has a bended centre portion and two end flanges which adjoin the respective ends of the centre portion and which are provided with through holes for tensioning means, wherein the centre portion has a narrowing width from the flanges towards the centre. This specific shape is advantageous because it allows the second clamping member to be arranged in the angle region at the underside of the diagonal bracing bar, at the location where the latter joins the head post.

### BRIEF DESCRIPTION OF THE DRAWINGS

The invention will be described in more detail in the following description of a preferred embodiment with reference to the drawings, in which:

FIG. 1 shows a child seat which can be mounted to a bicycle frame with a mounting assembly according to the invention,

FIG. 2 shows the child seat of FIG. 1 mounted on a bicycle by means of a mounting assembly known from the prior art,

FIG. 3a shows a perspective view of a preferred embodiment of a mounting assembly according to the invention,

FIG. 3b shows a front view of the mounting assembly of FIG. 3a,

FIG. 3c shows a side view of the mounting assembly of FIG. 3a,

FIG. 3d shows a top view of the mounting assembly of FIG. 3a,

FIG. 4 shows a perspective view of a main body of the mounting assembly of FIG. 3,

FIG. 5 shows a perspective view of a first clamping member of the mounting assembly of FIG. 3,

FIG. 6 shows a perspective view of a second clamping member of the mounting assembly of FIG. 3,

FIG. 7 shows a perspective view of an inner cover for the main body of FIG. 4,

FIG. 8 shows a perspective view of a covering cap for the main body of FIG. 4,

FIG. 9 shows a bicycle with the mounting assembly of FIG. 3 mounted on it,

FIG. 10 is shown a front view of a main body of an alternative mounting assembly, and

FIG. 11 is shown a part of a child seat provided with sockets adapted to be assembled with the main body of FIG. 10.

### DETAILED DESCRIPTION OF PREFERRED EMBODIMENTS

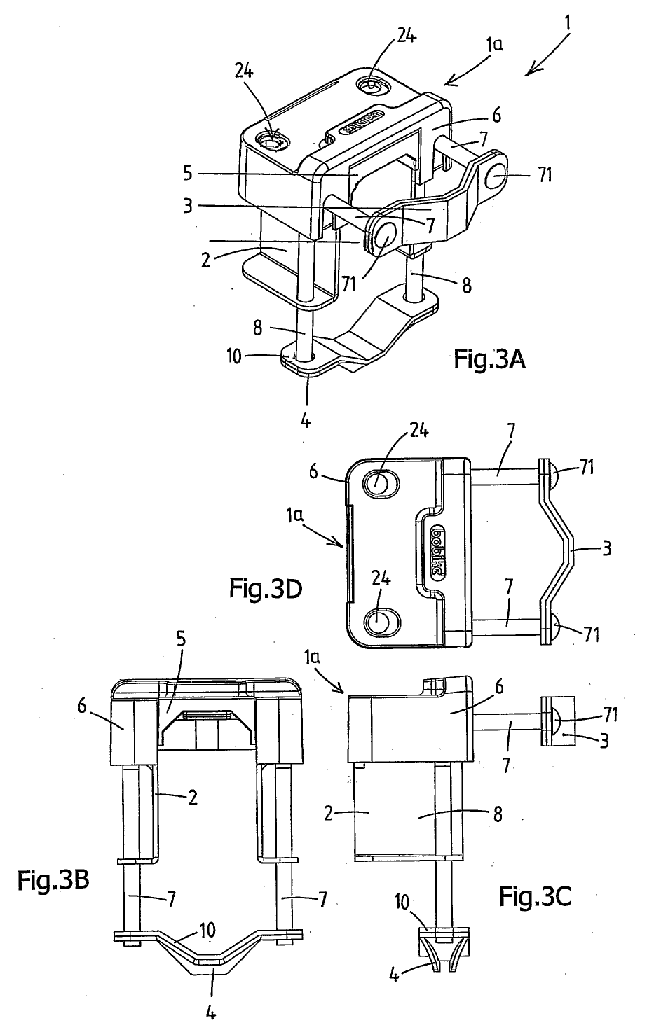

In FIGS. 3a-3d is shown a mounting assembly 1 in an assembled state. The mounting assembly 1 comprises in general a support member 1a as well as a first clamping member 3 and a second clamping member 4 which are coupled with the support member 1a by means of first bolts 7 and second bolts 8 respectively. The support member 1a comprises a main body 2, an inner cover element 5 and an outer covering cap 6.

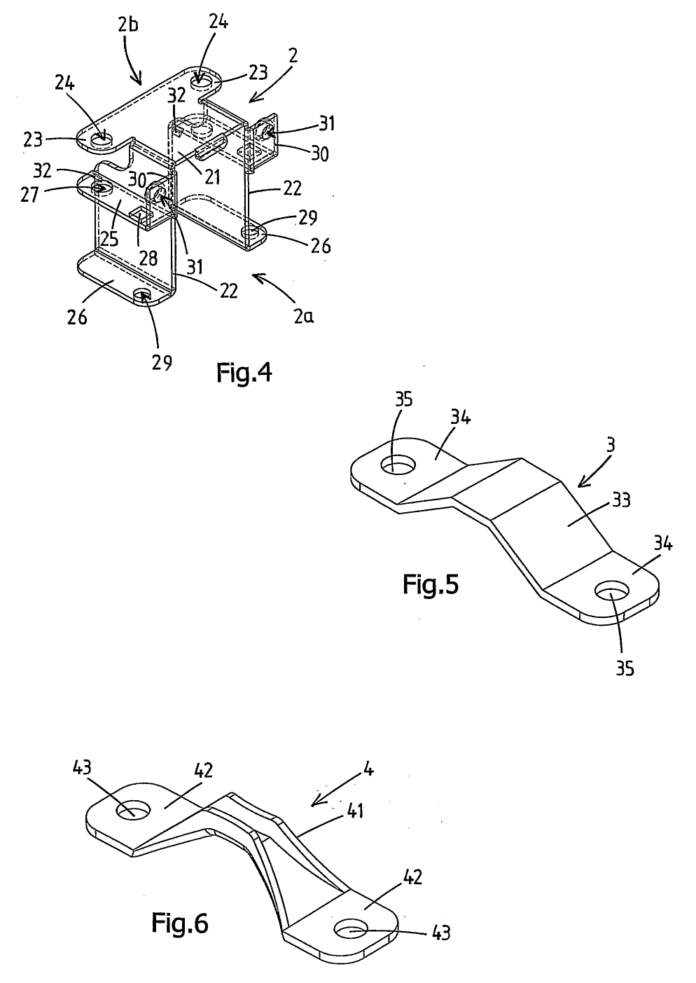

In FIG. 4 the main body 2 is shown separately. It has an upper plate 21 and two side plates 22 extending parallel to each other and substantially perpendicular from the upper plate 21. Consequently the main body 2 has a substantially U-shaped cross section in which the upper 21 plate forms the base of the U and the side plates 22 form the legs of the U.

The main body 2 has a font end 2a which in a mounted state is closest to the frame head and a rear end 2b opposite the front end 2a. At the rear end region of the upper plate 21 are arranged on either side laterally extending upper flanges 23, each provided with a through hole 24.

On each side plate 22 is arranged an intermediate flange 25 and a lower flange 26, both extending in a lateral direction and substantially parallel to the upper flanges 23. The intermediate flange 25 is spaced apart from the upper flange 23 and from the lower flange 26.

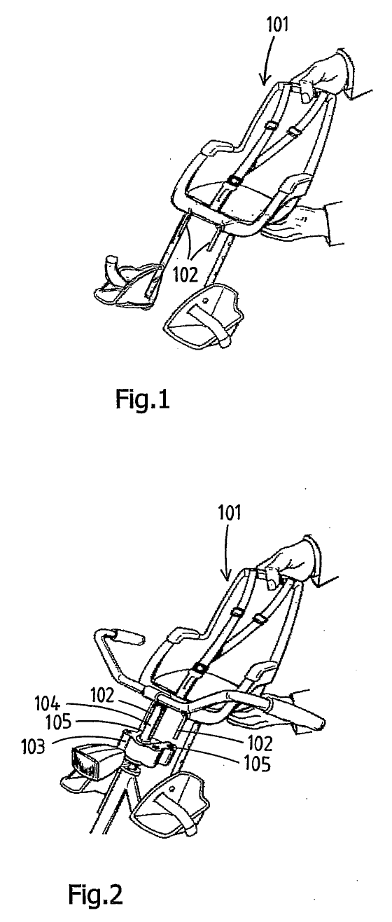

The intermediate flange 25 at its rear end region is provided with a through hole 27 which is in line with the through hole 24 in the upper flange. The through holes 24 and 27 are adapted to receive elongate assembly members like the assembly pins 102 of a child seat 101 as is depicted in FIG. 1. The through holes 24 and 27 thus constitute a receiving socket for the assembly pin 102 of the child seat.

The intermediate flange 25 at its front end region is provided with a through hole 28. The lower flange 26 at its front end region has a through hole 29 which is in line with the front end through hole 28 in the intermediate flange 25. The front end through holes 28 and 29 are adapted such that the shaft of the first bolt 7 may pass through it. The head of the bolt 7 in the mounted state is in engagement with the area around the through hole 28.

On the front end of the intermediate flange 25 is provided a front flange 30 which extends substantially perpendicular with respect to the side plate 22 and the intermediate flange 25. The front flange 30 is provided with a through hole 31 which is adapted such that the shaft of the bolt 7 may pass through it. In a possible embodiment an inner thread is provided in the hole 31 which can cooperate with an outer thread on the bolt 7. It is also possible to provide a nut or other element with an inner thread behind the front flange 30 for cooperating with the threaded bolt 7.

The main body 2 is formed of metal. The main body can be made of cast metal or metal plate elements welded together, but is preferably formed in one piece from sheet metal, e.g. of 2.5 mm thick, by cutting and bending. After the required cuts have been made in the sheet metal blank the side plates 22 are formed by bending the parts concerned at an angle of about 90° with respect to the upper plate 21. The upper wings 23, which are cut outs in the side plates 22, remain in the same plane as the upper plate 21. The lower flange 26 is formed by bending the lower end of the side plate outwardly at an angle of about 90°. The front flange 30 is formed by bending the relevant part with the adjoining intermediate flange part outwardly with respect to the side plate 22 under an angle of about 90°. Next, the intermediate flange 25 is formed by bending the part to form the intermediate flange backwards along the side plate 22. The rear end of the intermediate flange 25 is attached to the side plate 22 by means of a welding joint 32, such that the intermediate flange 25 is supported at both ends.

In FIG. 5 is shown the first clamping member 3, with a bended centre portion 33 and two substantially flat end flanges 34. In each of the end flanges 34 is provided a through hole 35 through which the shaft of the first bolt 7 may pass. In the mounted state a bolt head 71 of the bolt 7 engages the outer flange surface around the hole 35. The first clamping member 3 is preferably made of sheet metal by cutting and bending. The first clamping member could also be made of a suitable plastic. The inner surface of the clamping member 3 is covered by a protective element 9 for protecting the head post of the bicycle frame, which it engages in use, against scratching and damage of the paint by the first clamping member 3. Suitable materials for the protective element 9 are for example soft plastics, rubber or felt, which are known to be scratch inhibiting.

Although not particularly preferred at this moment the first clamping member can be provided with one or more receiving sockets for receiving one or more assembly pins of a child seat. This is advantageous with a not shown child seat where the assembly pins in the mounted state have to be located in front of the head post of the bicycle frame instead of behind the head post as is the case with the assembly shown in FIG. 3.

In FIG. 6 is shown the second clamping member 4, with a bended centre portion 41 and two flat end flanges 42. In each of the end flanges 42 is provided a through hole 43 through which the shaft of the second bolt 8 may pass. The centre portion 41 has a narrowing width from each of the flanges 42 towards the centre. The second clamping member 4 is preferably made of sheet metal by cutting and bending, but could also be made of a suitable plastic. The inner surface of the second clamping member 4 is covered by an element 10 for protecting the diagonal bracing bar of the bicycle frame, which it engages in use, against scratching and damage of the paint. Suitable materials for the element 10 are scratch inhibiting materials, e.g. soft plastics, rubber or felt.

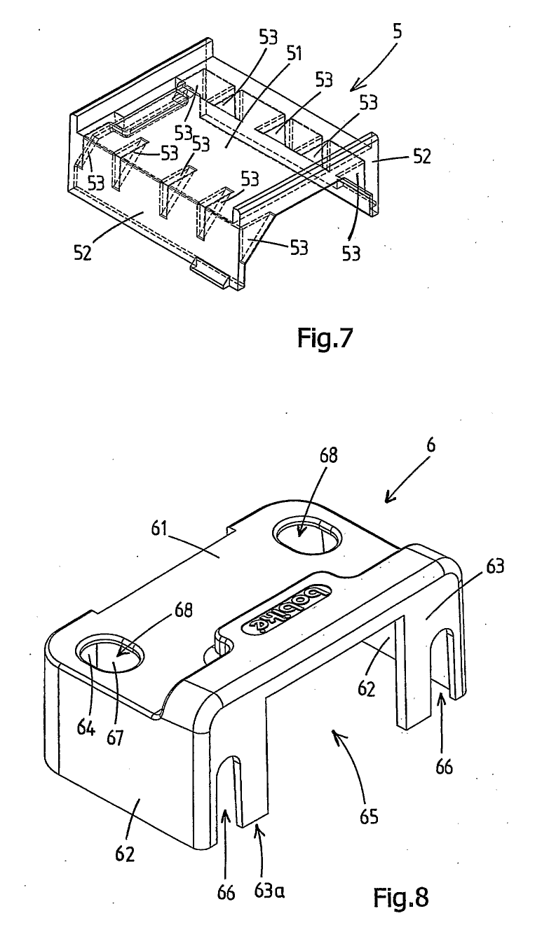

In FIG. 7 is shown the inner cover element 5 of the support member 1a. In an assembled state (cf. FIG. 3a) the cover element 5 is arranged against the lower side of the upper plate 21 between the side plates 22. The inner cover element 5 has a top wall 51 which is arranged against the lower side of the upper plate 21 of the main body 2. Furthermore, the cover element 5 has side walls 52 which are substantially perpendicular with respect to the top wall 51 and in the assembled state lie against the inner side of the side plates 22 of the main body 2. Between the top wall 51 and side walls 52 is arranged a plurality of triangularly shaped parallel gussets 53 for engagement on a cross bar of a bicycle frame. The inner cover element 5 is preferably made of a plastic material by means of injection moulding or another suitable manufacturing method. The material is chosen such that when mounting the support member 1a on the bicycle, the paint on the cross bar of the bicycle is not damaged.

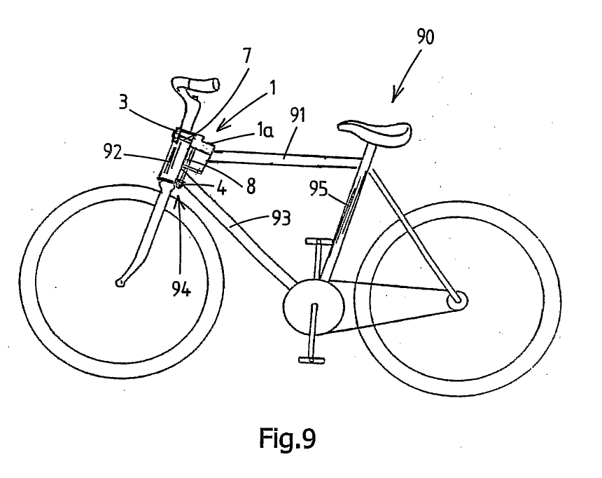

In FIG. 8 is shown the outer covering cap 6. This cap 6 has a top wall 61 and side walls 62 extending at an angle of about 90° with respect to the top wall 61. The cap 6 furthermore has a front wall 63 and a rear wall 64. In the front wall 63 is provided a central recess 65 for bridging in a mounted state the cross bar of the bicycle frame. On both sides of the central recess 65 are provided elongate slots 66, which extend from a lower edge 63a upwardly, that is in the direction of the top wall 61. The slots 66 in the mounted state are arranged in a transverse manner over the first bolts 7 as is best visible in FIG. 3a. In the rear wall 64 is also provided a central recess 67 which is in line with the central recess 65 in the front wall and which is also for bridging the cross bar of the bicycle. In the top wall 91 are arranged two holes 68 which in an assembled state are in line with the holes 24 and 27 in the upper flanges 23 and intermediate flanges 25 respectively of the main body 2, such that the assembly pins 102 of the child seat can be inserted into the support member 1a. The cap 6 is preferably made of plastic material by means injection moulding.

In FIG. 9 is shown a bicycle 90 with the mounting assembly 1 attached to it. The bicycle 90 has a frame comprising a cross bar 91, a head post 92, a diagonal bracing bar 93 and a saddle post 95. The mounting assembly 1 is mounted on the bicycle frame by arranging the support member 1a on top of the cross bar 91 against the rear side of the head post 92. The side plates 22 of the main body 2 pass along and possibly beyond the cross bar 91. The first clamping member 3 is arranged against the front side of the head post 92. The first bolts 7 are inserted through the holes 35 in the clamping member 3 and attached to the front flanges 30 of the main body 2. By tensioning the first bolts 7 the clamping member 3 and the support member 1a are tightly clamped against the headpost 92. The head of the second bolt 8 is in an assembled state locked between the main body 2 and the cap 6. The bolts 8 in the mounted state extend downward beyond the diagonal bracing bar 93 of the frame (cf. FIG. 9). The second clamping member 4 is slid over the bolt ends of the second bolts 8 and arranged in the angle region 94 between the head post 92 and the diagonal bracing bar 93 of the bicycle frame. Nuts are screwed on the threaded part of the second bolts 8 and the connection is tightened by tensioning the bolt/nut connection. The specific shape of the second clamping member 4 allows for a better arrangement and tighter engagement of it in the angle region 94 between the head post 92 and the diagonal bracing bar 93 of the bicycle frame.

Most of the bicycles with a cross bar 91 have some space at the head post 92 above the connection with the cross bar 91 and has an angle region 94 at the connection between the head post 92 and the lower diagonal bracing bar 93. Consequently the mounting assembly 1 described above can be widely used in combination with a whole variety of bicycle frames. The bolts 7 and 8 can be made available in a range of lengths, such that the user can readily select the suitable shaft length adapted for his bicycle frame dimensions. The rest of the assembly parts can be equal for the whole range of frame dimensions.

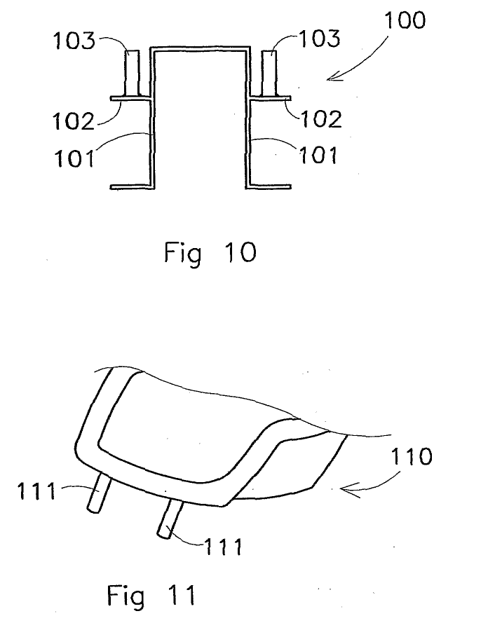

Although not particularly preferred at this moment, it is also envisaged that the support member of the mounting assembly is provided with one or more protruding assembly members, e.g. pins, which in a mounted state substantially extend parallel with the steering axis. In FIG. 10 an example of a main body of such a support member is shown, which is generally comparable with the one shown in FIG. 4. However, instead of the flanges 23 and 25 of the main body 2 (cf. FIG. 4) provided with the through holes 24, 27 constituting sockets, the side plates 101 of the main body 100 have each one flange 102 which is provided with an assembly pin 103 which in a mounted state extends in an upward direction. The child seat 110 in this embodiment, which is partly shown in FIG. 11, is provided with one or more receiving sockets, e.g. constituted by tubular members 111, for receiving the assembly members 103 of the support member. The main body 100 can be mounted on a bicycle in the same way as the main body 2 from FIG. 4.

It has to be understood that the embodiments described in the above with reference to the FIGS. 3-11 are described as non limiting examples. Variations and modifications that fall within the scope of the claims are readily recognizable by a person skilled in the art.

1. A mounting assembly for mounting a child seat on a bicycle, comprising:
a support member and clamping means for attaching the support member to a head portion of a bicycle frame, the support member being provided with one or more receiving sockets each for receiving an assembly member fixedly attached to the child seat and protruding therefrom, which sockets in a mounted state substantially extend parallel with the steering axis,
wherein the support member has a bearing portion for engaging an upper side of a substantially horizontal cross bar of the bicycle frame, and
wherein the clamping means comprise a first clamping member for engaging a head post of the frame and a second clamping member for engaging a diagonal bracing bar of the frame.

2. The mounting assembly according to claim 1, wherein the clamping means comprise first tensioning means, which in a mounted state interconnect the first clamping member and the support member, for bringing the first clamping member and the support member in a clamping engagement with the head post of the bicycle frame.

3. The mounting assembly according to claim 1, wherein the clamping means comprise second tensioning means, which in a mounted state interconnect the second clamping member and the support member, for bringing the second clamping member in a clamping engagement with the diagonal bracing bar of the bicycle frame and the support member in a clamping engagement with the cross bar of the bicycle frame.

4. The mounting assembly according to claim 1, wherein the support member comprises a main body having an upper plate and two side plates extending from the upper plate, such that the main body has a substantially U-shaped cross section in which the upper plate forms the base of the U and the side plates form the legs of the U, the upper plate in the mounted state being positioned on the upper side of the cross bar of the bicycle frame and the side plates passing along the cross bar.

5. The mounting assembly according to claim 2, wherein the support member has at least one pair of first attachment holes for attachment with the first tensioning means.

6. The mounting assembly according to claim 5, wherein the first attachment holes are provided in a first flange on the main body.

7. The mounting assembly according to claim 3, wherein the support member has at least one pair of second attachment holes for attachment with the second tensioning means.

8. The mounting assembly according to claim 7, wherein the second attachment holes are provided in a second flange on the main body.

9. The mounting assembly according to claim 1, wherein each of the receiving sockets in the support member for the assembly pins are constituted by through holes in at least two parallel flanges.

10. The mounting assembly according to claim 8, wherein each of the receiving sockets in the support member for the assembly pins are constituted by through holes in at least two parallel flanges, and wherein the second flange constitutes one of the parallel flanges.

11. The mounting assembly according to claim 1, wherein the main body of the support member is formed in one piece from sheet metal.

12. The mounting assembly according to claim 1, wherein the support member further comprises an inner cover element of a scratch inhibiting material which covers the bearing portion of the main body.

13. The mounting assembly according to claim 12, wherein the inner cover element is made from plastic or rubber material.

14. The mounting assembly according to claim 1, wherein the second clamping member has a bended centre portion and two end flanges which adjoin the respective ends of the centre portion and are provided with through holes for tensioning means, the centre portion having a narrowing width from the flanges towards the centre.

15. The mounting assembly according to claim 1, wherein the first clamping member has a bended centre portion and two end flanges which adjoin the respective ends of the centre portion and are provided with through holes for tensioning means.

16. The mounting assembly according to claim 1, wherein the clamping members have a protective layer of scratch inhibiting material provided on their engagement side.

17. A mounting assembly for mounting a child seat on a bicycle, the child seat comprising:
one or more sockets which in a mounted state substantially extend parallel with the steering axis,
the mounting assembly comprising:
a support member and clamping means for attaching the support member to a head portion of a bicycle frame, the support member being provided with one or more protruding assembly members,
wherein the support member has a bearing portion for engaging an upper side of a substantially horizontal cross bar of the bicycle frame, and
wherein the clamping means comprise a first clamping member for engaging a head post of the frame and a second clamping member for engaging a diagonal bracing bar of the frame.

18. A combination of a mounting assembly according to claim 17 and a bicycle child seat with one or more assembly members attached to it and protruding therefrom for coupling said seat with said mounting assembly.

19. A combination of a mounting assembly according to claim 1 and a bicycle child seat with one or more assembly members attached to it and protruding therefrom for coupling said seat with said mounting assembly.
